(19) United States
(12) Patent Application Publication
(10) Pub. No.: US 2004/0015264 A1
(43) Pub. Date: Jan. 22, 2004

(54) Apparatus and method for verification of container numbers during unloading and loading of ships by container cranes in container terminals

(75) Inventors: Maarten Holland, Poxdorf (DE); Wolfgang Wichner, Wendelstein (DE)

Correspondence Address: Henry M. Feiereisen, Suite 4714, 350 Fifth Avenue, New York, NY, 10118, US

(73) Assignee: SIEMENS AKTIENGESELLSCHAFT, Munchen, Germany

(21) Appl. No.: 10/445,384

(22) Filed: May 23, 2003

(30) Foreign Application Priority Data
May 31, 2002 (DE) 102 243 13.1

(51) Int. Cl. G06F 7/00

(52) U.S. Cl. 700/225; 414/137.1

(57) ABSTRACT

In an apparatus for verifying a container number of a container during unloading and loading of ships by a container crane in a container terminal, a camera system is mounted to the container crane for optically ascertaining a container number imprinted on an upper right-hand corner of a container sidewall to generate an image. Operatively connected to the camera system is an image evaluation system for identifying the container number that has been shot by the camera system. The image evaluation system cooperates with an administrative computer, which is provided in the container terminal, in such a manner that the identified container number is compared with a stored container number in the administrative computer.

### CROSS-REFERENCES TO RELATED APPLICATIONS

This application claims the priority of German Patent Application, Serial No. 102 24 313.1, filed May 31, 2002, pursuant to 35 U.S.C. 119(a)-(d), the disclosure of which is incorporated herein by reference.

### BACKGROUND OF THE INVENTION

The present invention relates to an apparatus and method for verification of container numbers during unloading and loading of ships by container cranes in container terminals.

Unloading and loading of ships by means of container cranes requires a determination of a container number on each handled container in order to ensure that the container is placed at the intended site in the storage yard of the container terminal or on the ship. Hereby, the container numbers are read by the deck crew on the ship or by the crane operator and recorded in lists or keyed into portable electronic registration devices. These processes not only require added personnel and are time consuming but errors during determination and during later comparison with cargo lists cannot be precluded.

As a result, attempts were made to develop detection systems which include an identification device to recognize the containers, whereby the identification device is constructed to allow readout by a machine. This approach suffers shortcomings because millions of containers currently in use worldwide have to be retrofitted with respective identification devices.

It would therefore be desirable and advantageous to provide an improved apparatus and method for verification of container numbers during unloading and loading of ships by container cranes in container terminals, to obviate prior art shortcomings and to enable a determination and verification of container numbers on all presently existing containers, without requiring modifications to the containers.

### SUMMARY OF THE INVENTION

According to one aspect of the present invention, an apparatus for verifying a container number of,a container during unloading and loading of ships by a container crane in a container terminal, includes a camera system mounted to a container crane for optically imaging a container number imprinted at an upper right-hand corner of a container sidewall, an image evaluation system operatively connected to the camera system for identifying the container number acquired by the camera system, and an administrative computer provided in the container terminal and cooperating with the image evaluation system for comparing the identified container number with a stored container number in the administrative computer.

The present invention resolves prior art problems by providing an identification and verification of the container numbers as the containers are moved around and transferred. In other words, the verification process takes place during operations that are anyway required so that delays during transshipping are avoided and modifications to existing containers is not necessary.

According to another feature of the present invention, the image evaluation system may be integrated in the camera system. Of course, such integration is not necessarily required so long as the image evaluation system is operatively connected to the camera system.

According to another feature of the present invention, the camera system is disposed approximately at half height of the container crane. Suitably, the camera system is disposed on the right hand side of the container crane, preferably at a central location between an on-shore crane leg and an off-shore crane leg of the container crane. In this way, the location of the container numbers on the right-hand upper corner of the container sidewall is taken into account so that the camera system is placed at an optimum arrangement on the container crane.

According to another feature of the present invention, the camera system may include a motor-driven swiveling device for moving the camera system in vertical and horizontal directions, so that the camera system can be accurately aligned with the container number being optically acquired. Suitably, the camera system may include a motor-driven zooming device to bring the container number into sharp focus of the camera system.

According to another feature of the present invention, the camera system is operatively connected to a crane control for transmitting data relating to a position of the container, supported by a load-carrying member or spreader of the container crane, to the camera system so that the container number can be determined at sufficient size and sufficient sharpness. The crane control may include a first device for determining a lifting height of the load-carrying member, and a second device for determining a position of the trolley which supports the load-carrying member. Optionally, the crane control may also include, a swing control device for determining a swing angle of the container upon the load-carrying member. Thus, the camera system can be properly aligned and focused to the right-hand upper corner of the container sidewall by the swiveling device and the zooming device in response to the data transmitted by the crane control.

In order to eliminate any adverse influence arising from daylight, the camera system may include a flash reflector which is operated by the swiveling device for alignment to the right-hand upper corner of the container sidewall and thus to the container number, and which is constructed to radiate at a narrow angle In this way, it is possible, to generate two snapshots immediately one after the other, with one snapshot taken with flash and the other snapshot taken without flash. Through differential evaluation of the images, daylight influences can be eliminated, e.g. by electronically subtracting grey values of the two snapshots.

According to another aspect of the present invention, a method of verifying a container number of a container during unloading and loading of ships by a container crane in a container terminal, includes the steps of optically ascertaining a container. number imprinted on a right-hand upper corner of a container sidewall by a camera system, thereby generating an image, transmitting the image to an image evaluation system for identifying the container number, and comparing the container number with a stored container number in cooperation with an administrative computer of the container terminal.

In order to realize a precise determination of the container numbers, data relating to a position of the container on the load-carrying member is transmitted to the camera system, so that the camera system can be aligned and focused to the right-hand upper corner of the container sidewall in response to the transmitted position data.

The container number identified by the image evaluation system may be transmitted to the administrative computer of the container terminal, and compared with an expected predetermined container number inputted in the administrative computer. As an alternative, it is also possible to transmit the expected predetermined container number from the administrative computer of the container terminal to the image evaluation system for comparison with the identified container number in the image evaluation system.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side view of a basic configuration of a container crane provided with an apparatus according to the present invention for verification of container numbers;

FIG. 2 is a plan view of the on-shore components of the container crane of FIG. 1; and

FIG. 3 is a block diagram of the apparatus according to the present invention, showing an exemplified relationship between components of the apparatus.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale. Details which are not necessary for an understanding of the present invention or which render other details difficult to perceive may have been omitted.

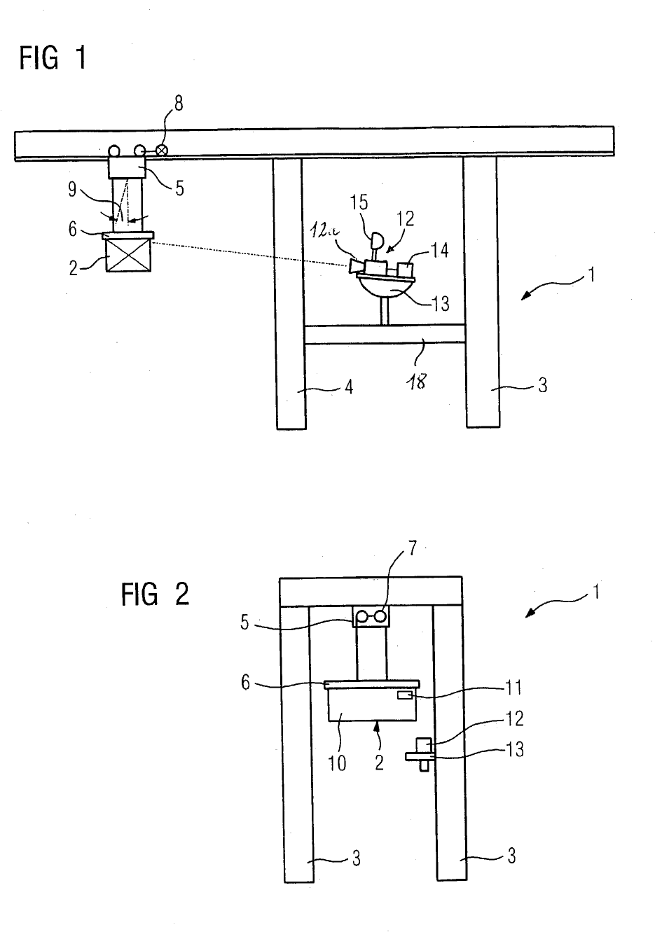

Turning now to the drawing, and in particular to FIG. 1, there is shown a side view of a basic configuration of a container crane, generally designated by reference numeral 1 and forming an operational part of a container terminal (not shown). The container crane 1 is provided to load containers 2 from the container terminal onto ships (not shown) or to unload containers 2 from the ships to the container terminal. In the non-limiting example of FIG. 1, the container crane 1 includes a footing block comprised of on-shore crane legs 3 and off-shore crane legs 4. A trolley 5 is movably arranged on the container crane 1 for supporting a load-carrying member or spreader 6 which is movable in a vertical direction for lifting and lowering a container 2.

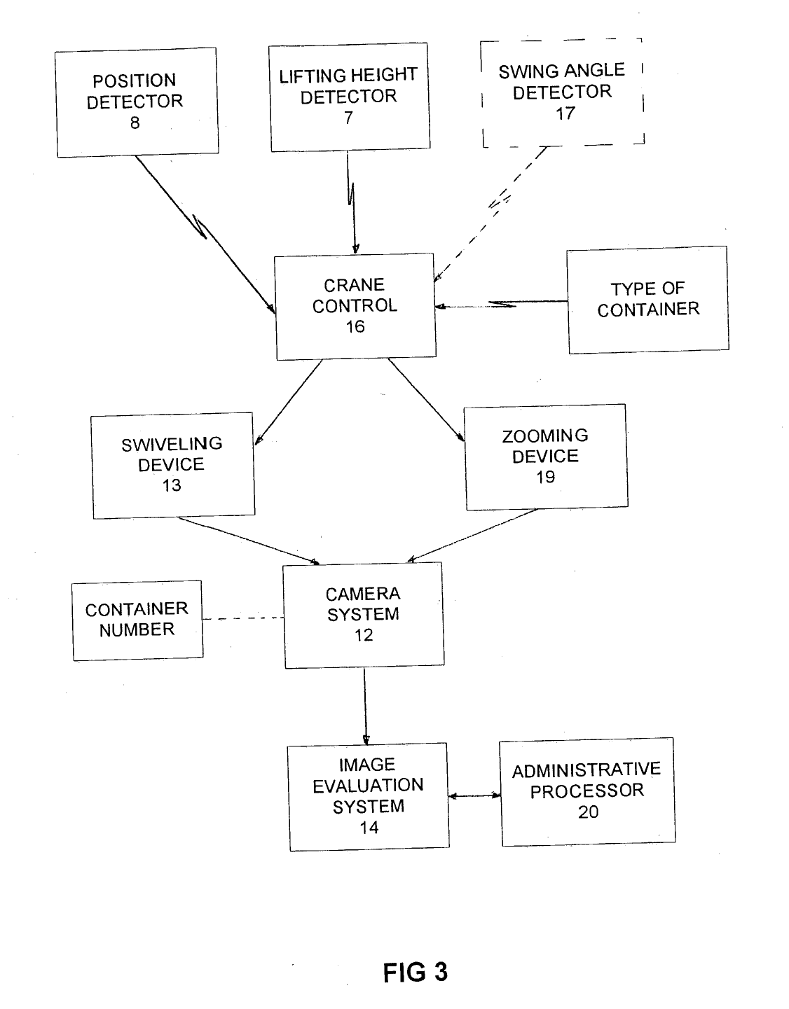

A crane control unit 16 (FIG. 3) is associated to the container crane 1 and, as shown in FIG. 2, receives data from a first detector 7 for determining a vertical position of the load-carrying member 6 and thus of the container 2, attached to the load-carrying member 6, in relation to the trolley 5 and the container crane 1. The crane control 16 is further operatively connected to a second detector 8 for measuring and ascertaining the position of the trolley 5 in relation to the container crane 1. As shown in FIG. 3 and indicated by broken line, the crane control may optionally also be operatively connected to a third detector 17 by which a swing angle 9 is measured and determined and which relates to a swinging motion of the load-carrying member 6 and the attached container 2 with respect to the trolley 5.

The crane control 16 is thus able in response to the data received by the first and second detectors, 7, 8 and, optionally, third detector 17 to continuously determine the actual spatial position of the load-carrying member 6 and thus of the attached container 2. In addition, as shown in FIG. 3, the crane control 16 receives information about the type of container 2 attached to the load-carrying member 6, i.e. whether the container 2 is a 20-foot container in length, 40-foot container or 45-foot container, or whether there are two 20-foot containers 2 in twin arrangement on the load-carrying member 6.

Every typical container 2 currently in use is imprinted on their container sidewalls 10 at the upper right-hand corner with container numbers 11, whereby each container 2 is assigned a different container number 11. In order to ascertain the container number 11 of the container 2 attached to the load-carrying member 6, the container crane 1 is provided with a camera system, generally designated by reference numeral 12. In the event, the load-carrying member 6 of the container crane 1 supports two 20-foot containers, the camera system 12 is configured to read both container numbers 11 in succession. As shown in FIGS. 1 and 2, the camera system 12 is mounted onto a crossbar 18 approximately in half height of the container crane 1 at a central location between the right on-shore crane leg 3 and the right off-shore crane leg 4. The view direction is hereby the direction toward the water side, i.e. toward the ship situated in the container terminal.

The arrangement of the camera system 12 on the right side of the container crane 1, as shown in FIG. 2, is selected to take into account the provision of the container numbers 11 in the upper right-hand corner of the container sidewalls 10 of the container 2.

The camera system 12 includes a camera 12a, a swiveling device 13 for moving the camera system 12 in vertical and horizontal directions, and a zooming device 19 for bringing the camera 12a into focus with the container number 11. As shown in FIG. 3, the camera system 12 is operatively connected to the crane control 16 of the container crane 1 so that data relating to the spatial position of the container 2, attached to the load-carrying member 6 of the container crane 1, can continuously be transmitted to the camera system 12. In response to the positional data of the container 2, the camera system 12 is aligned by the swiveling device 13 and the zooming device 19 with the right-hand upper corner of the container sidewall 10 so as to provide an image of the container number 11 at sufficient size and sufficient focus.

The camera system 12 further includes an image evaluation system 14 for identifying the container number 11 imaged by the camera system 12. The container number 11 identified in the image evaluation system 14 is transmitted to an administrative computer 20 of the container terminal or dock master computer, which checks whether the container number of the expected container matches the container number 11 of the container 2 attached to the load-carrying member 6 of the container crane 1.

As an alternative, it is, of course, also possible, that the administrative computer 20 of the container terminal or the dock master computer transmits the container number of the expected container to the image evaluation system 14. In this case, verification of the container number is implemented in the image evaluation system 14.

As further shown in FIG. 1, the camera system 12 may further be equipped with a separate flash reflector 15 which radiates light within a narrow angle and can be positioned in alignment with the container number 11 of the container 2 on the upper right-hand corner of the container sidewall 10 together with the camera system by the swiveling device 13. The flash of the flash reflector 15 is synchronized with a shutter of the camera system 12. When ascertaining the container number 11, two snapshots are taken immediately one after the other, whereby one snapshot is taken with flash and the other snapshot is taken without flash. In order to prevent daylight to adversely affect the determination of the container number 11, a differential evaluation of the snapshots is carried out, i.e. the grey values of both snapshots are electronically subtracted from one another so that the image quality is independent on the daylight.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. Apparatus for verifying a container number of a container during unloading and loading of ships by a container crane in a container terminal, comprising:
a camera system mounted to a container crane for optically ascertaining a container number imprinted on an upper right-hand corner of a container sidewall;
an image evaluation system operatively connected to the camera system for identifying the container number acquired by the camera system; and
an administrative computer provided in the container terminal and cooperating with the image evaluation system for comparing the identified container number with a stored container number in the administrative computer.

2. The apparatus of claim 1, wherein the image evaluation system is integrated in the camera system.

3. The apparatus of claim 1, wherein the camera system is disposed approximately at half height of the container crane.

4. The apparatus of claim 1, wherein the camera system is disposed on the right hand side of the container crane.

5. The apparatus of claim 1, wherein the camera system is disposed at a central location between an on-shore crane leg and an off-shore crane leg of the container crane.

6. The apparatus of claim 1, wherein the camera system includes a motor-driven swiveling device for moving the camera system in vertical and horizontal directions.

7. The apparatus of claim 1, wherein the camera system includes a motor-driven zooming device.

8. The apparatus of claim 1, wherein the camera system includes a motor-driven swiveling device for moving the camera system in vertical and horizontal directions, and a motor-driven zooming device, and further comprising a crane control for transmitting data relating to a position of the container provided on the load-carrying member to the camera system, said crane control including a first device for detecting a lifting height of a load-carrying member supported on a trolley of the container crane, and a second device for determining a position of the trolley, said camera system being aligned in a desired position by the swiveling device and focused to the right-hand upper corner of the container sidewall by the zooming device in response to the data transmitted by the crane control.

9. The apparatus of claim 1, wherein the crane control includes a swing control device for determining a swing angle of the container on the load-carrying member.

10. The apparatus of claim 6, wherein the camera system includes a flash reflector operated by the swiveling device for alignment to the right-hand upper corner of the container sidewall and the container number, said flash reflector radiating at a narrow angle of radiation.

11. A method of verifying a container number of a container during unloading and loading of ships in a container terminal, comprising the steps of:
optically ascertaining a container number imprinted on a right-hand upper corner of a container sidewall by a camera system, thereby generating an image;
transmitting the image to an image evaluation system for identification of the container number; and
comparing the container number with a stored container number in cooperation with an administrative computer of the container terminal.

12. The method of claim 11, and further comprising the steps of transmitting data relating to a position of the container on a load-carrying member to the camera system, and aligning and focusing the camera system to the right-hand upper corner of the container sidewall.

13. The method of claim 12, wherein the transmitting step includes detecting a lifting height of a load-carrying member of the container crane, and determining a position of a trolley which supports the load-carrying member.

14. The method of claim 13, wherein the transmitting step includes determining a swing angle of the container on the load-carrying member.

15. The method of claim 11, wherein the comparing step includes transmitting the container number identified by the image evaluation system to the administrative computer of the container terminal, and comparing the identified container number with an expected predetermined container number inputted in the administrative computer.

16. The method of claim 11, wherein the comparing step includes transmitting the expected predetermined container number from the administrative computer to the image evaluation system, and comparing the expected predetermined container number with the container number identified by the image evaluation system.

17. The method of claim 11, and further comprising the steps of taking two snapshots of the container number in immediate succession, wherein one of the snapshots is taken with flash and the other one of the snapshots is taken without flash, and electronically subtracting grey values of both snapshots.

18. A container crane for moving a container between locations, comprising:
a footing block for support of a movable trolley which has a load-carrying member to carry a container having a sidewall provided with a particular container number; and
a verification system for identifying the container number, said verification system including a control unit for generating data relating to an actual position of the container, and a camera system mounted to the footing block in confronting relationship to the sidewall of the container and rendered operative in response to the data transmitted by the control unit for alignment with the container number to thereby generate a corresponding image, an image evaluation system operatively connected to the camera system for identifying the container number in response to the image received from the camera system, and an administrative computer operating in cooperation with the image evaluation system for comparing the identified container number with a predetermined container number stored in the administrative computer.

19. The container crane of claim 18, wherein the control unit includes a first detector for determining a lifting height of a load-carrying member, and a second detector for determining a position of the trolley.

20. The container crane of claim 18, wherein the camera system includes a motor-driven swiveling device for moving, the camera system in vertical and horizontal directions, and a motor-driven zooming device.

21. The container crane of claim 19, wherein the control unit includes a third detector for determining a swing angle of the container on the load-carrying member.

22. The container crane of claim 18, wherein the verification system includes a flash reflector operating in synchronism with the camera system and directed toward the container number, said flash reflector radiating at a narrow angle of radiation.

23. A method of verifying a container number of a container during unloading and loading of ships, comprising the steps of:
generating an image of a container number provided on a container sidewall;
transmitting the image to an image evaluation system for identification of the container number; and
comparing the container number with a stored container number in cooperation with an administrative computer.
